(19) United States
(12) Patent Application Publication
(10) Pub. No.: US 2004/0061995 A1
(43) Pub. Date: Apr. 1, 2004

(54) Portable computer docking station for vehicles

(76) Inventor: Edward L. McMahon, Stratford, CT (US)

Correspondence Address: Edward L. McMahon, 85 Ruby Lane, Stratford, CT, 06614, US

(21) Appl. No.: 10/259,344

(22) Filed: Sep. 28, 2002

(51) Int. Cl. G06F 1/16

(52) U.S. Cl. 361/681

(57) ABSTRACT

A docking station for a vehicle is provided. The docking station includes mechanisms for removably securing a portable computer to the ceiling of a vehicle. The portable computer can be secured to the ceiling in an upside down position such that a video screen of the portable computer is movable between a first position and a second position. The docking station allows images on the video screen to be viewed by occupants of the vehicle, once the images are rotated to a correct viewing orientation by software in the portable computer.

### BACKGROUND

The present disclosure relates generally to portable computers. More specifically, the present disclosure relates to portable computer docking stations for vehicles.

Modern vehicles, such as cars, trucks, minivans, and the like, are being provided with more and more features for the convenience, comfort, and entertainment of the driver and passengers. For example, modern vehicles are being provided with entertainment systems that include video screens connected to one or more video recording devices, video game systems, television receiving devices (e.g., satellite receivers), and the like.

The video screens can include LCD screens, plasma screens, and others. The video recording devices can include VCR players, DVD players, and others. The video game systems can include systems from NINTENDO, SONY, and others.

Two types of competing entertainment systems have emerged in the marketplace. Some entertainment systems are permanently mounted in the vehicle (e.g., non-portable systems). Other entertainment systems are portable devices that can be removably mounted in the vehicle.

In the non-portable entertainment systems, the video screen can be pivotally secured to the ceiling of the interior of the vehicle for movement between a viewing position and a stored position. Alternately, the video screen can be mounted on the dashboard, in one or more seat backs, and other positions in the vehicle. In the non-portable entertainment systems, the size of the video screen has been limited to about 9 inches (as measured diagonally). The video recording devices can be mounted under one or more of the vehicle seats, between the vehicle seats, and other positions in the vehicle.

The cost of the non-portable entertainment systems has reduced the appeal of such systems to many consumers. Additionally, the fact that these entertainment systems are permanently mounted in the vehicle has also reduced the appeal of such systems to many consumers, since these high cost systems can only be used in the vehicle.

To resolve the issue of being permanently installed in the vehicle, portable entertainments systems have been developed. These entertainment systems are often provided in a console or carrying case. The console/case can be removably mounted to in the vehicle, such as being securing to seat backs in the vehicle. In this way, the system can be used in the vehicle and outside of the vehicle. However and due to the portable nature of such systems, the size of the video screen has been limited to typically 5 inches or less.

There is a continuing need for entertainment systems for vehicles that reduce the cost and improve the usability of the system.

### SUMMARY

A docking station for a vehicle is provided. The docking station includes mechanisms for removably securing a portable computer to the ceiling of a vehicle. The portable computer can be secured to the ceiling in an upside down position such that a video screen of the portable computer is movable between a first position and a second position. The docking station allows images on the video screen to be viewed by occupants of the vehicle, once the images are rotated to a correct viewing orientation by software in the portable computer.

An entertainment system for a vehicle is also provided. The system includes a portable computer and a docking station. The computer has a base portion and a video screen. The video screen is movable with respect to the base portion between a first position and a second position. The docking station removably secures the base portion to a ceiling of the vehicle such that the video screen is viewable by occupants of the vehicle when in the first position. The system also includes means for rotating an image on the video screen such that the image appears in a correct viewing orientation to the occupants.

A vehicle is provided that includes an occupant compartment and a docking station configured to removably secure a portable computer to the ceiling of the compartment. The docking station removably secures the portable computer to the ceiling such that images from a video screen of the computer are displayed in a first orientation and are viewable by occupants in the compartment. Means are also provided for rotating the image to a second orientation.

The above described and other features are exemplified by the following figures, detailed description, and claims.

### DESCRIPTION OF THE FIGURES

FIG. 1 is a rear perspective view of a portable computer in a non-use position;

FIG. 2 is a front perspective view of the portable computer of FIG. 1 in a use position;

FIG. 3 is a side view of a portable computer installed in an exemplary embodiment of a docking station;

FIG. 4 is a top perspective view of an exemplary embodiment of a docking station;

FIG. 5 is a bottom perspective view of the portable computer of FIG. 1; and

FIGS. 6-8 illustrate a method of securing the portable computer of FIG. 1 to the docking station of FIG. 4.

### DETAILED DESCRIPTION

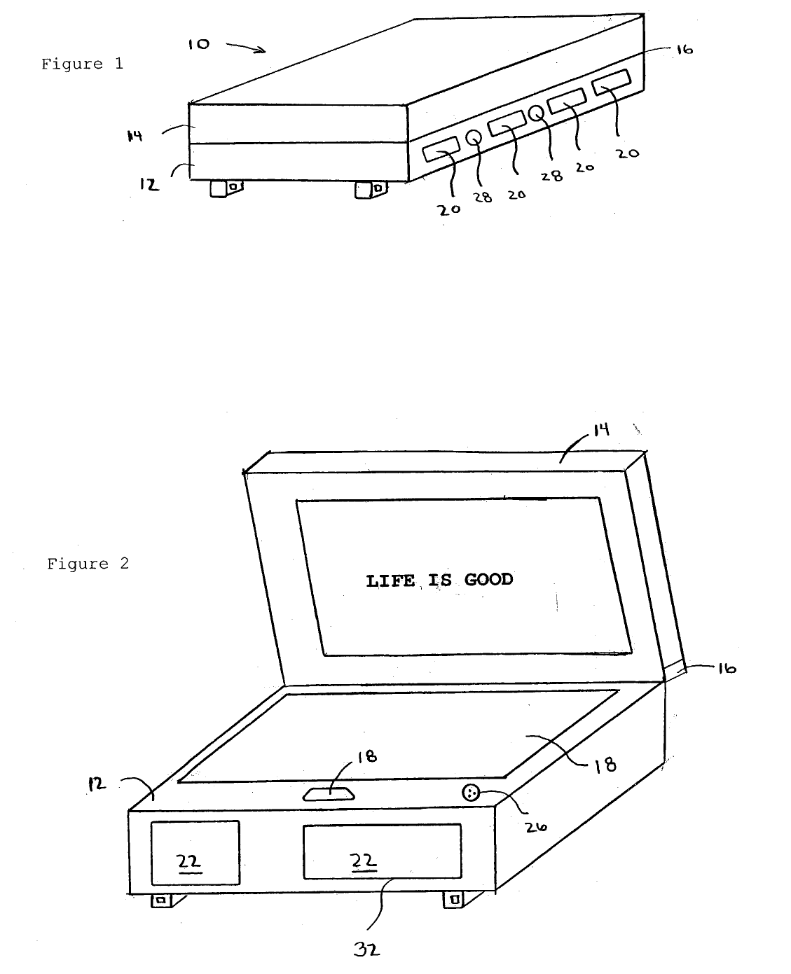

Referring now to the figures and in particular to FIGS. 1-2, a portable computer 10 is illustrated. Computer 10 can be a laptop computer, a notebook computer, or other types of portable computers having a base portion 12 and a video screen portion 14 where the screen is pivotally mounted to the base by a hinge mechanism 16. Here, screen 14 is movable between a non-use position (FIG. 1) and a use position (FIG. 2). In the use position, screen 14 is generally perpendicular to base portion 12.

Computer 10 includes common devices and systems in the field of computing. For example, computer 10 can include one or more data entry devices 18, one or more communication ports 20, and one or more disk drives 22. Computer 10 also includes a processing unit, a battery, and other features, none of which are shown for purposes of clarity.

Data entry devices 18 can include keyboards, mouse devices, joystick devices, and the like. Data entry devices 18 can also include wireless communication devices, such as wireless keyboards, wireless mouse devices, wireless joystick devices, and the like.

Communication ports 20 can include USB ports, parallel ports, serial ports, speakers 26, speaker jacks 28, microphones, microphone jacks, power inlet port 30, and the like. Drives 22 can include 5-inch floppy disk drives, 3.5-inch disk drives, CD ROM drives, and the like.

Computer 10 also includes a digital video disk (DVD) drive 32. Accordingly, computer 10 is configured to display information from a DVD placed within drive 32 on screen 14 and to play sound from the DVD through speakers 26 and/or speakers connected to speaker ports 28.

Prior art devices and systems have been used to integrate such portable computers into vehicles for the purposes of using the vehicle as a portable office. The demands of using the portable computer in this manner require certain design constraints on the system. For example, these systems typically require easy access to the data entry devices of the portable computer and viewing of the video screen from the driver's seat of the vehicle. In contrast, the present application is directed to devices and methods for using the portable computer as an entertainment system within the vehicle.

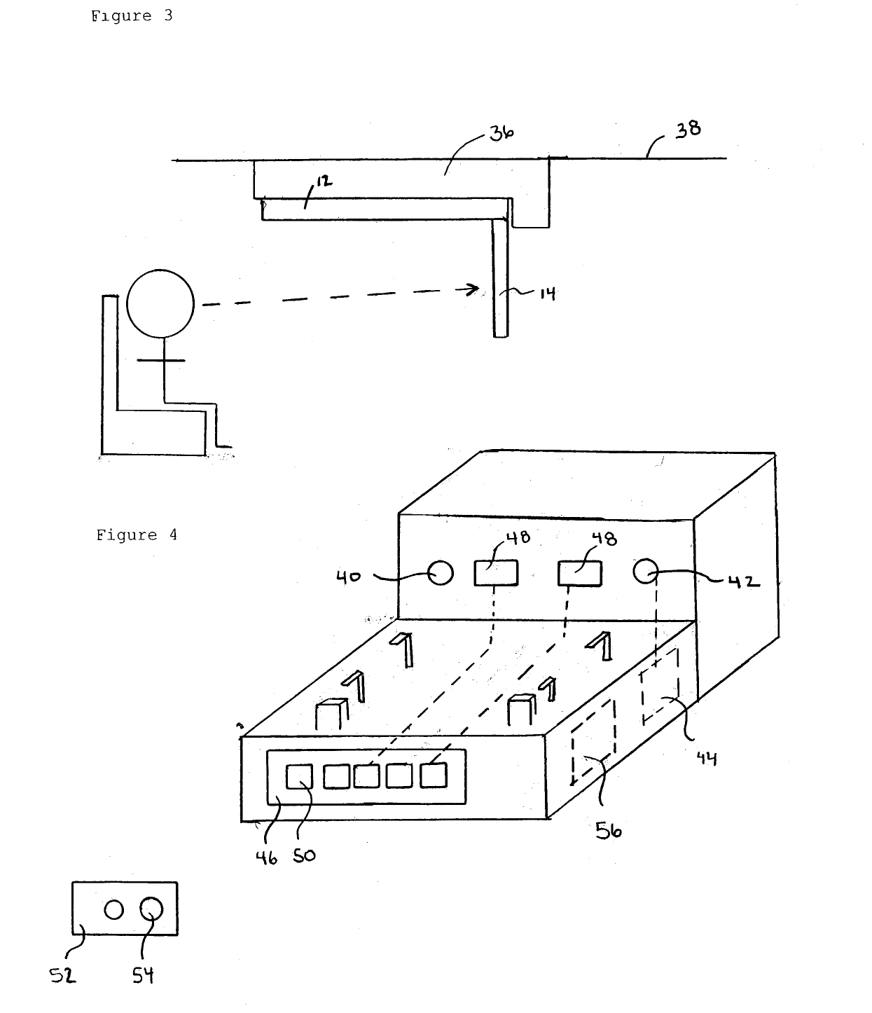

Accordingly and turning now to FIGS. 3-8, an exemplary embodiment of a docking station 36 is illustrated. Station 36 is configured to removably mount and integrate computer 10 into a ceiling 38 of the occupant compartment of a vehicle. This allows computer 10 to be used in the vehicle as an entertainment system.

Specifically, docking station 36 is configured to removably secure base portion 12 of computer 10 to a ceiling 38 of the vehicle in an upside down position. Docking station 36 is also configured to allow screen 14 to move between its use and non-use positions, when the base portion is secured to the ceiling. Thus, station 36 allows computer 10 to present screen 14, in the use position to occupants of the vehicle.

However, images on screen 14 would appear in an inverted or upside down position. In a preferred embodiment, computer 10 includes software, which causes the image to be rotated 180 degrees on the screen, to compensate for the inverted mounting of the computer. As will be described in more detail below, docking station 36 can provide an input to computer 10 when the computer is removably mounted in the station. This input activates the image rotating software. Thus, computer 10 can rotate the image when installed in the docking station, but does not rotate the image when remote from the docking station. Accordingly, docking station 36 allows the computer to be used as an entertainment system in the vehicle by displaying images in a proper orientation to occupants in the vehicle.

In the illustrated embodiment, computer 10 is configured to provide entertainment functions such as displaying images on the video screen from the DVD drive 32. Computer 10 can also be configured to allow the computer to receive and display television signals in a known manner. Computer 10 can include hardware and software configured to allow the computer to play video games stored on its internal memory and/or from one or more of the drives 22.

Many benefits to the consumer are provided by this entertainment system. For example, the screen sizes of computer 10 can be as large as 14 inches, which is larger than prior portable and non-portable entertainment systems. In addition, the price of many computers 10 is substantially equal to the price of many of the prior entertainment systems. However, the consumer receives the added benefit of being able to use the computer outside of the vehicle when it is not needed in the car. Namely, the consumer gets two products (e.g., a vehicle entertainment system and a portable computer) for the price of one. Additionally, when computer 10 and docking station 36 are purchased together with a vehicle, the consumer can finance the computer with the price of the car.

Docking station 36 is illustrated in FIG. 4 in an inverted position for purposes of clarity. Station 36 includes a power plug 40. Plug 40 is in electrical communication with the power system (e.g., battery, alternator) of the vehicle. When computer 10 is removably secured in station 36, plug 40 mates with power inlet port 30 of computer 10. Thus, station 36 allows power from the vehicle to be provided to the computer. In this way, computer 10 and/or its battery can be provided with power from the vehicle.

Station 36 can include means for providing an output to a sound system in the vehicle. For example, station 36 can include a speaker plug 42. Plug 42 is in electrical communication with the sound system (e.g., stereo and speakers) of the vehicle. When computer 10 is removably secured in station 36, plug 42 mates with speaker jack 28 of computer 10. Thus, station 36 allows sound from computer 10 to be played by the sound system of the vehicle.

The electrical communication between plug 42 and the vehicle's sound system can be provided by a wired connection between the plug and the sound system. Alternately, station 36 can include a transmitter 44 (illustrated in phantom). Transmitter 44 can be configured to wirelessly communicate sound signals from plug 42 to the vehicle's sound system.

Station 36 can also include one or more plugs 46 and a control panel 48. When computer 10 is removably secured in station 36, plugs 46 can mate with other communication ports 20 of computer 10. For example, plugs 46 can be configured to place computer 10 in electrical communication with control panel 48.

Control panel 48 includes one or more common entertainment system controls 50, such as a power button, a play button, a stop button, a rewind button, a volume increase button, volume decrease button, and the like. Buttons 50 are in electrical communication with computer 10 by way of the interconnection of plugs 46 and ports 20. Thus, control panel 48 is configured to communicate with the computer through communication ports 20. Station 36 therefore allows the user to easily operate computer 10 without having to access the data entry devices 18 of computer 10.

As discussed above, docking station 36 can provide an input to computer 10. For example, depressing any one of buttons 50 on control panel 48 send a corresponding input to computer 10 through plugs 46. This input can be configured to activate the image rotating software, to turn on the computer, and other control functions.

Control panel 48 can also be configured to wirelessly communicate with a remote control 52, which also includes buttons 54. Thus, computer 10 can also be remotely controlled from within the vehicle. In addition, computer 10 can communicate wirelessly with, for example, a wireless mouse, a wireless joystick, a remote control, and others. In this embodiment, computer 10 can be used for video games, or other computing functions (e.g., word processing, internet, and the like).

Station 36 can also include a VCR device 56 (illustrated in phantom). VCR device 56 can integral to the station 36 as illustrated. Alternately, VCR device 56 can be remote from the station, but in electrical communication with the station. In this configuration, station 36 allows for the playing of both DVD's and VCR tapes.

Plugs 46 can also be configured to place computer 10 in electrical communication with one or more systems of the vehicle. For example, computer 10 can communicate with a vehicle antenna (not show) to aid the computer in receiving television signals. Computer 10 can also communicate with a mobile telephone (not show) integrated into the vehicle to aid the computer in establishing an Internet connection.

Docking station 36 comprises means for removably securing base portion 12 of computer 10 to ceiling 38 of the vehicle. The means allows screen 14 to be moved between the use and non-use positions when computer is secured in the docking station. Additionally, the means allows access to various portions of computer 10 when the computer is secured within docking station 36, such as but not limited to an on/off button of the computer, one or more of drives 22, and others.

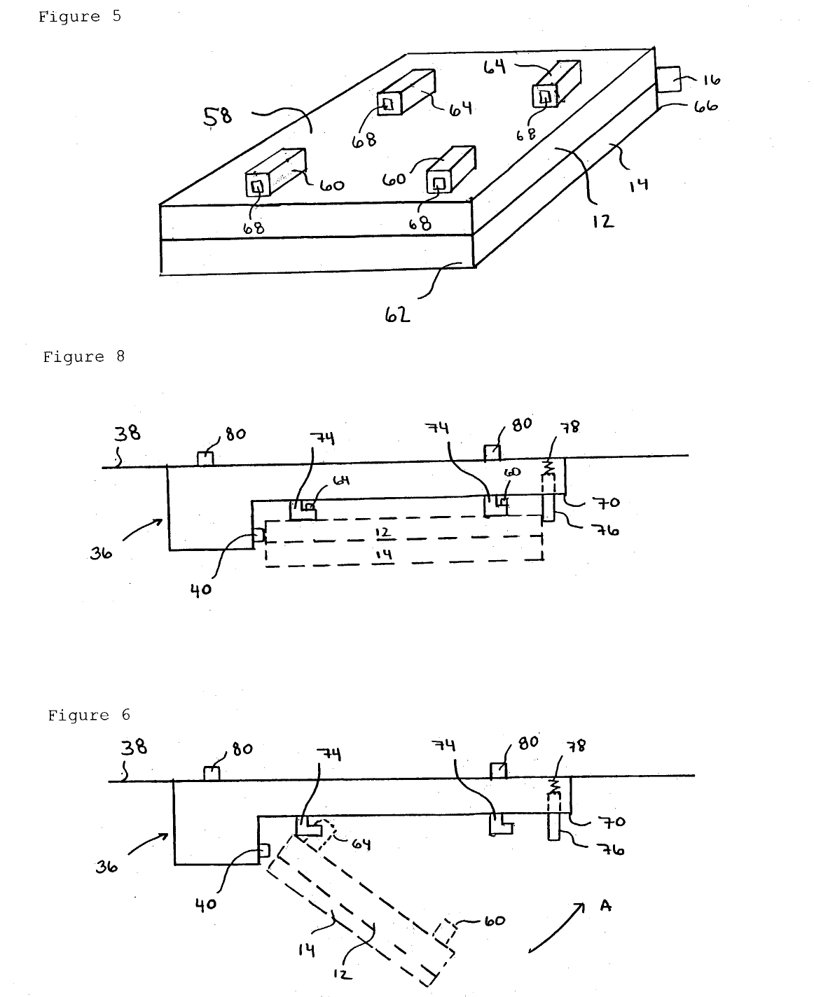

Turning now to FIGS. 5-6, an exemplary embodiment of the means for removably securing computer 10 to docking station 36 is illustrated. Computer 10 can include support members disposed at a bottom surface 58 of base portion 12. For example, computer 10 can include a pair of first support members 60 proximate a front edge 62 of computer 10, and can include a pair of second support members 64 proximate a rear edge 66 of computer 10 (e.g., proximate hinge 16).

Support members 60 and 64 can be integrally formed on base portion 12. Alternately, support members 60 and 64 can be adhesively or mechanically connected to the base portion. Each support member 60 and 64 defines an opening 68.

Docking station 36 can include extension members disposed at a support surface 70 thereof. For example, station 36 can include a pair of first extension members 72 proximate front edge 62 of computer 10, and can include a pair of second support members 74 proximate rear edge 66 of computer 10.

The extension members 72 and 74 are configured, dimensioned, and positioned to be received in openings 68 of the support members 60 and 64 (FIG. 8).

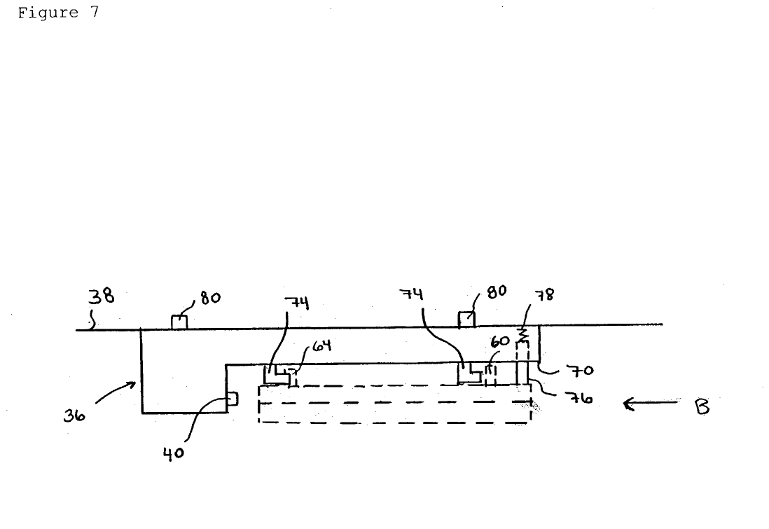

Station 36 can also include a locking member 76. Locking member 76 is movable between a first position (FIGS. 6 and 8) and a second position (FIG. 7). In the first position, locking member 76 extends from support surface 70 of the docking station 36. In the second position, a portion of locking member 76 is retracted into surface 70. Locking member 76 is biased by a biasing means 78, such as a spring, to the first position.

In order to install computer 10, screen 14 is typically moved to its non-use position. The second support members 64 are engaged with the second extension members 74. Computer 10 is then pivoted upwards along arrow A in FIG. 6 until bottom surface 58 of the computer abuts locking member 76 and causes the locking member to retract. Namely, the computer 10 is rotated until the force on locking member 76 is sufficient to over come biasing means 78, which causes the locking member to move from the first position to the second position.

Next, computer 10 is moved backwards in the direction of arrow B (FIG. 7) until first support members 60 are engaged with first extension members 72. Additionally, the movement of computer 10 in the direction of arrow B causes communication ports 20 on computer 10 to mate with the plugs of the docking station, placing the computer and the docking station in electrical communication with one another.

At this point, the bottom surface 58 of computer is no longer abutting locking member 76. Once the bottom surface is clear of locking member 76, biasing means 78 causes the locking member to return to the first position. Front edge 62 of computer 10 abuts locking member 76, when the locking member is in the second position. Thus, locking member 76, when in the second position, prevents computer 10 from moving in a direction opposite arrow B. Accordingly, computer 10 is supported by the cooperation of the extension members and the support members, and is locked in place by the locking member.

Computer 10 can be easily removed from station 36 by simply reversing the aforementioned process. Namely, computer 10 is removed by moving locking member 76 to the second position and pulling the computer in the direction opposite arrow B until the support members are no longer engaged with the extension members.

Docking station 36 can be rigidly secured to ceiling 38 by way of mechanical fasteners 80, such as bolts, clips, and the like. Of course, other non-mechanical means of securing the station to the ceiling, such as but not limited to adhesives and the like, are contemplated in the scope of the present disclosure.

By way of example only, station 36 is described herein for use with a computer 10 having communication ports 20 located along its rear edge. Of course, the docking station can easily be configured for use with computers having other configurations.

Various portions of computer 10 are accessible when the computer is secured within docking station 36. For example, DVD drive 32 can be accessed. In order to use computer 10 as a DVD player, a user simply turns on the computer and installs a DVD in driver 32. The operation of computer 10 can then be controlled using control panel 46, remote control 52, and combinations thereof.

It should be recognized that the means for removably securing the computer to the docking station are described above by way of example only. Any means for removably securing the computer to the docking station that allows the screen to be moved between the use and non-use positions and that allows access to selected portions of computer when the computer is secured within the docking station are contemplated to be in the scope of the present disclosure.

It should also be noted that the terms “first”, “second”, and “third” may be used herein to modify elements performing similar and/or analogous functions. These modifiers do not imply a spatial, sequential, or hierarchical order to the modified elements, unless otherwise indicated.

While the invention has been described with reference to one or more exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A docking station for a vehicle, comprising:
means for removably securing a base portion of a portable computer to a ceiling of an occupant compartment of the vehicle, said portable computer having a video screen portion movable with respect to said base portion between a first position and a second position, said video screen portion being movable between said first and second positions when said means removably secures said base portion to said ceiling, said video screen portion being viewable by a vehicle occupant when in said first position, and said means being configured to allow access to one or more disk drives of said computer when said means removably secures said base portion to said ceiling, wherein said portable computer includes software configured to rotate an image displayed on said video screen portion such that said image appears in a selected viewing orientation with respect to a vehicle occupant.

2. The docking station as in claim 1, further comprising:
a plurality of electrical connections configured to place said portable computer and the docking station in electrical communication with one another.

3. The docking station as in claim 2, wherein said plurality of electrical connections of the docking station are configured to place said portable computer in electrical communication with one or more systems of said vehicle.

4. The docking station as in claim 3, wherein said one or more systems of said vehicle are selected from the group consisting of an electrical power source, a vehicle antenna, a mobile telephone, a vehicle sound system, and combinations of the foregoing.

5. The docking station as in claim 3, wherein at least one of said plurality of electrical connections is configured to communicate wirelessly with at least one of said one or more systems of said vehicle.

6. The docking station as in claim 2, further comprising:
a control panel in electrical communication with said plurality of electrical connections such that said portable computer can be controlled by said control panel without having to access data entry devices of said portable computer.

7. The docking station as in claim 6, wherein said control panel includes entertainment system controls selected from the group consisting of a power button, a play button, a stop button, a rewind button, a volume increase button, and volume decrease button.

8. The docking station as in claim 7, wherein said control panel is configured to provide a signal to said portable computer to activate said image rotating means.

9. The docking station as in claim 7, wherein said control panel is configured to wirelessly communicate with a remote control such that said portable computer can be controlled by said remote control.

10. The docking station as in claim 1, further comprising a VCR device.

11. An entertainment system for a vehicle, comprising:
a portable computer having a base portion and a video screen, said video screen being movable with respect to said base portion between a first position and a second position; and
a docking station configured to removably secure said base portion of said portable computer to a ceiling of the vehicle such that said video screen is movable between said first and second positions, said video screen being viewable by occupants of the vehicle when in said first position, wherein said portable computer includes software means for rotating an image on said video screen such that said image appears in a selected viewing orientation to said occupants.

12. The entertainment system as in claim 11, further comprising:
a plurality of electrical connections disposed on said docking station, said electrical connections being configured to place said portable computer in electrical communication with said docking station

13. The entertainment system as in claim 12, wherein said docking station is in electrical communication with one or more systems of said vehicle.

14. The entertainment system as in claim 13, wherein said one or more systems of said vehicle are selected from the group consisting of an electrical power sources, a vehicle antenna, a mobile telephone, a vehicle sound system, and combinations of the foregoing.

15. The entertainment system as in claim 12, further comprising:
a control panel in electrical communication with said plurality of electrical connections such that said portable computer can be controlled by said control panel without having to access data entry devices of said portable computer.

16. The entertainment system as in claim 11, wherein said image is selected from the group consisting of television signals, digital video disk signals, video games, word processing programs, and internet pages.

17. A vehicle, comprising:
an occupant compartment having a ceiling;
a docking station configured to removably secure a portable computer to said ceiling such that images from a video screen of said portable computer are displayed in a first orientation, said images being viewable by occupants in said occupant compartment; and
means for rotating said image to a second orientation.

18. The vehicle as in claim 17, further comprising a plurality of electrical connections configured to place said portable computer in electrical communication with one or more systems of said vehicle.

19. The vehicle as in claim 17, further comprising said portable computer.

20. The vehicle as in claim 17, wherein said docking station further comprises:
a control panel in electrical communication with said portable computer so that said portable computer can be controlled by said control panel without having to access data entry devices of said portable computer.
